(19) United States
(12) Patent Application Publication
(10) Pub. No.: US 2004/0163649 A1
(43) Pub. Date: Aug. 26, 2004

(54) Disposable face mask with skin-care face-contacting layer

(76) Inventor: Zechuan Shao, Santa Clara, CA (US)

Correspondence Address: Donald W. Meeker, 924 East Ocean Front, #E, Newport Beach, CA, 92661, US

(21) Appl. No.: 10/374,587

(22) Filed: Feb. 26, 2003

(51) Int. Cl. A62B 7/10

(52) U.S. Cl. 128/205.27

(57) ABSTRACT

A disposable face mask which includes an innermost facing layer, worn next to the wearer's face that provides skin care. The innermost layer is coated by an impregnating the layer with a solution comprising moisturizing and therapeutic skin care compositions including Aloe Vera, Vitamin E, Vitamin C, Grape Seed Extract and Peppermint. The solution moisturizes, soothes and heals the user's face during the wearing of the face mask, thereby reducing skin irritations. The face mask of the present invention may include other layers, such as at least one generally coextensive intermediate filter media layer and at least one generally coextensive outer facing layer.

### BACKGROUND OF THE INVENTION

1. Field of the Invention

The present invention relates to novel disposable face masks, more particularly, to a multi-layered disposable face mask which includes a moisturizing and therapeutic innermost facing layer worn next to the wearer's face, that is coated with Aloe Vera, Vitamin E, Vitamin C, Grape Seed Extract and Peppermint.

2. Description of the Prior Art

Face masks, especially disposable face masks, serve many purposes and are widely used in today's healthcare, medical, scientific, mining, industrial, farming and environmental workplaces. In order to effectively filter air and/or prevent the spread of germs, face masks typically include multiple layers, such as one or more outer facing layer, one or more intermediate filter media layers and one or more inner facing layers. During use, the masks fit quite closely with most of the inner surface being in contact with the face of the user.

Face masks are frequently found to be warm and uncomfortable during use, especially when they are used over an extended period of time for example, in prolonged surgical procedures. An ever present problem associated with face masks is moisture, due to warm, moist air exhaled by the wearer, perspiration and also the contacting between mouth and the innermost facing layer. Such moisture can result in the buildup of dampness on the face and the masks, especially the inner facing layer. The face mask often becomes wet and abraded. When this happens, the abraded material from the inner surface may irritate the wearer, and the face mask becomes uncomfortable to wear.

Further, the moist environment on the face and the inner layer of the mask may also allow bacteria and viruses to grow and multiply.

Another problem is caused by the fluffed fibers on the surface of the inner facing layer and chemicals used in the manufacturing process of fabrics may also irritate the wearers with sensitive skin.

Prior art face masks have not adequately solved these problems.

Prior art U.S. Pat. No. 6,041,782, issued Mar. 28, 2000 to Angadjivand, provides a respiratory mask having a molded, cup-shaped, shape-retaining shell on the concave side of which is a layer of filter material and, on the concave side of the filter material, without any intermediate shape-retaining layer, a layer of nonwoven material. The layer of filter material and the inside layer are conformed into the cup-shaped configuration of the shape-retaining shell. The inside layer is preferably a smooth BMF material offering improved comfort to the wearer.

Prior art U.S. Pat. No. 5,699,792, issued Dec. 23, 1997 to Reese, claims a face mask that includes a filter body capable of filtering liquids, particles and aerosols of a size appropriate for the mask's intended purposes, while providing excellent breathability and comfort for extended periods of wear. The filter body may be formed from multiple layers of filtration material having a generally rectangular configuration with multiple pleats. The mask may be secured to the head of a wearer by ear loops or surgical tie strips attached to flaps extending from the filter body to form a fluid seal between the periphery of the mask and the wearer's face. For some applications, strips of resilient or stretchable material which further enhance both the fluid seal formed by the mask and comfort for the wearer may be attached along each side of the filter body with surgical tie strips or ear loops attached to the strips of resilient material.

Prior art U.S. Pat. No. 5,467,765, issued Nov. 21, 1995 to Maturaporn, describes a pleated, disposable, liquid-resistant face mask formed of a three-ply or four-ply composite laminate structure that is conformable to the shape of the wearer's face. The three-ply face mask has a first ply formed of a non-woven material, a carded cotton material, and a creped tissue wadding material; a second ply formed of a non-woven, meltblown, polypropylene material; and a third ply formed of a non-woven, thermobond, polypropylene material. In the four-ply mask, there is an additional ply of non-woven, colored, spunbond, polypropylene material which may be of any color and acts as the face-contacting surface of the face mask.

Prior art U.S. Pat. No. 5,374,458, issued Dec. 20, 1994 to Burgio, discloses a molded, cup-shaped face mask having a first, second and third layer, especially useful for medical and dental personnel. Edge portions of the layers are substantially free of adhesion to one another, and outer edges of the mask are free of any peripheral seal or the like, so that the edge portions of all three layers are movable relative to each other and present a soft, comfortable feel to the wearer. Exhalation of air through the mask is facilitated by the flexible nature of the edge portions, and during inhalation the flexible edge portions are drawn toward a position of conformed contact with the wearer's face.

Prior art U.S. Pat. No. 4,856,509, issued Aug. 15, 1989 to Lemelson, indicates an invention that relates to improvements in face masks, particularly for use in preventing the spread of disease such as colds, influenza and the like wherein a select portion or portions of such mask contain a disease or viral destroying chemical or biological agent, such as an acid or other material impregnating or forming part of a portion of the mask, such as that portion which extends across the nasal and mouth portions of the face of a wearer. In one form, the chemical or biological agent is in the form of a solid, such as a coating or a multitude of particles or crystals disposed against a porous portion of the mask or an insert which is attachable to and replaceable with respect to a mask frame or holding unit. In another form, such chemical is in the form of a liquid. In a third form, such chemical is disposed within a multitude of micro capsules which are ruptured or otherwise activated when the mask is used and which dispense their contents during such use and distribute the same throughout a select portion of the mask. In a particular form, the mask is formed of a unitary sheet of porous paper, cellular plastic or non-woven fiber with a portion of the outer layer thereof impregnated with a viral killing chemical, such as citric acid, to prevent passage of viral agents either from a person using the mask or from the atmosphere.

Prior art U.S. Pat. No. 5,869,072, issued Feb. 9, 1999 to Berry, puts forth a therapeutic applique for treatment of dry hands, either as a patch, face mask, or glove. The applique has the form of a porous, flexible sheet that is applied to the skin, and the sheet has a water-activatable material carried on its surface and also permeating its pores. The water-activated material, when in a dry, inactive state, preferably has a moisture content of less than 10% by weight, of the sheet, and is soluble in water. The arrangement is such that when the applique is applied to the skin, along with water, the applique's water-soluble component partially disassociates from it and leaches onto the skin, either while the sheet is in place on the skin or prior to the sheet being placed on the skin. In addition, with time the outermost layer of the water-soluble component undergoes evaporation, causing it to partially re-solidify, thereby forming an occlusive outer barrier which tends to retain the remaining water-soluble components between itself and the skin. There results improved, all natural skin moisturization, without preservatives and without undesirable greasy or oily residue being left on the skin.

Prior art U.S. Pat. No. 3,603,315, issued Sep. 7, 1971 to Becker, concerns a surgical mask having an inner layer of soft polymeric foam material that is worn against the face. The mask includes an intermediate layer of filter material and an outer layer of nonwoven material that is relatively impervious to airborne bacteria. The soft foam layer increases the comfort of the mask and allows the mask to conform to the face of the wearer. Further, the foam layer readily absorbs perspiration and saliva and passes these fluids to the middle filter layer, thereby maintaining the layer adjacent to the face soft and dry.

Thus there is a need for an economical and easily manufacturable comfortable face mask that can apply skin-care compositions to the face of wearer to maintain and/or improve the skin health of the wearer during prolonged wearing of mask, and to minimize the skin irritation, while at the same time, retain the primary functions of conventional face masks.

### SUMMARY OF THE INVENTION

A primary object of the present invention is to satisfy the above needs by providing an economical and easily manufactured, comfortable face mask that can apply skin-care compositions to the face of wearer. The face mask maintains and/or improves the skin health of the wearer during wearing of mask, and minimizes skin irritation, while at the same time, retaining the primary functions of conventional face masks.

A corollary object of the present invention is to soothe and condition the wearer's face during application of the mask by including an innermost facing layer coated with Aloe Vera, Vitamin E, Vitamin C, Grape Seed Extract and Peppermint.

Another object of the present invention is to minimize contact between the face and the fibers and other composite chemicals containing in the inner facing layer, resulting in less skin irritation.

Another object is to provide an improved comfortable face mask while not affecting the primary functions of the mask.

Still another object of the present invention to provide an improved disposable face mask which is comfortable to wear over an extended period of time, and also economical and easily manufacturable.

The above objects are accomplished by including the face mask an innermost facing layer coated with Aloe Vera, Vitamin E, Vitamin C, Grape Seed Extract and peppermint.

In brief, the present invention is a novel disposable multi-layered face mask including an innermost facing layer coated with Aloe Vera, Vitamin E, Vitamin C, Grape Seed Extract and peppermint. The face mask provides a skin protective barrier with a therapeutic benefit. The face mask also minimizes the abrasion between the face and inner facing layer, resulting in less skin irritation. When in moist environments the face mask releases skin-care compositions and transfers them to the skin by normal contact, thereby maintaining and/or improving the skin health of the wearer.

Aloe Vera has been widely used for the treatment of various skin conditions for thousands of years. Studies have shown that aloe Vera facilitates the healing of wounds and damaged skin tissue. It also exerts anti-fungal and antibacterial effects. It has moisturizing and pain relieving properties for the skin lesions, in addition to healing effects. Aloe Vera also prevents skin damage resulting from exposure to ultraviolet radiation associated with direct sunlight.

Aloe Vera is a frequent moisturizing ingredient in cosmetics and hair care products. Aloe-containing creams, gels, and ointments are used for minor burns, sunburn, cuts, and abrasions, wounds, and skin irritations. Aloe is also found in many shampoos, soaps, suncreens, skin creams and other cosmetics that are used to soothe, heal, protect, and moisturize the skin.

Vitamin E is well known as an antioxidant responsible for proper functioning of the immune system and for maintaining health skin. It helps keep skin smooth and soft, improves skin moisture by offsetting dryness caused by aging and environmental factors. Natural water soluble Vitamin E (d alpha tocopherol), is derived from natural sources. Studies have shown that it is more easy to be absorbed by skin and more effective than the synthetic version, usually made from petrochemicals.

Vitamin E is a potent antioxidant by itself, but its effectiveness is magnified when applied with other antioxidants, especially with Vitamin C.

Vitamin C has been found to be an effective ingredient in skin care treatments. Vitamin C acts as a major anti-oxidant and anti-inflammatory. Antioxidants fight against oxygen free radicals, which are stimulated by exposure to UV light, tobacco smoke, and other environmental insults. Those oxygen free radicals can damage and destroy the skin.

Grape seed extract is the primary commercial source of a group of powerful antioxidants known as oligomeric proanthocyanidins (OPCs). Studies have indicated OPCs are much more effective than vitamin C and vitamin E in neutralizing free oxygen radicals, which contribute to organ degeneration and aging in humans. Grape seed extract is a mixture of complex compounds and has wide range of therapeutic uses, its antioxidant properties are believed to help slow the aging process. One of the extract's most popular uses is in treating the affects of aging, including preventing wrinkles by protecting the skin against ultraviolet radiation damage from sunburn, improving skin elasticity and tone, and helping reduce the appearance of scars and stretch marks.

Peppermint (Mentha piperita) is a natural hybrid of water mint (Mentha aquatica) and spearmint (mentha spicata). Peppermint is a cooling, relaxing herb that contains properties that help ease inflamed tissues, calm muscle spasms or cramps, and inhibit bacteria and microorganisms. It also has pain-relieving and infection preventing qualities.

An advantage of the present invention is to soothe and condition the wearer's face during application of the mask by including an innermost facing layer coated with Aloe Vera, Vitamin E, Vitamin C, Grape Seed Extract and peppermint.

Another advantage of the present invention is that it minimizes contact between the face and the fibers and other composite chemicals containing in the inner facing layer, resulting in less skin irritation.

Yet another advantage of the present invention is in providing an improved comfortable face mask while not affecting the primary functions of the mask.

Still another advantage of the present invention is to provide an improved disposable face mask which is comfortable to wear over an extended period of time, and also economical and easy to manufacture.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a perspective view of the disposable face mask ready for use with the body of the mask configured in a series of folds;

FIG. 2 is a side elevational view of the disposable face mask of FIG. 1 is it would be on the face of a user with the folds puffed out by the facial features of the wearer;

FIG. 3 is a cross-sectional view of the disposable face mask taken through 3-3 of FIG. 1 showing the layers of the face mask;

FIG. 4 shows an alternate version of the face mask with elastic straps on each side running from the top corner to the bottom corner, with each elastic stretched behind the ear of the wearer.

### BEST MODE FOR CARRYING OUT THE INVENTION

A disposable multiple layer face mask 20 and 20A comprises at least one skin care layer 26, an inner facing layer 26 adjacent to the skin. The inner facing layer 26 is coated or impregnated with moisturizing and therapeutic skin care compositions. The skin care compositions are capable of being released in a moist environment by perspiration and warm, moist air exhaled by a wearer. The skin care compositions are capable of being transferred to the wearer's skin by normal contact. The disposable multiple layer face mask 20 further comprises at least one intermediate filter media layer 25, and at least one outer facing layer 24, which combine to serve the normal functions of a face mask relative to spreading diseases via airborne germs.

The inner facing layer 26 is coated by an impregnating of the layer 26 with a solution of Aloe Vera, Vitamin E, Vitamin C, Grape Seed Extract and Peppermint by methods preferably such as dip coating, spray coating, roll coating and rod coating. The Aloe Vera, Vitamin E, Vitamin C, Grape Seed Extract and Peppermint may be applied onto the fibers and fibrous materials used to form the fabrics above before or during the forming of a series of continuous webs forming the fabrics. The solution of Aloe Vera, Vitamin E, Vitamin C, Grape Seed Extract and Peppermint may be applied on a series of continuous webs forming the layer 26 before the web is cut to define individual mask bodies 21, and may be applied on the defined individual mask bodies, and also may be applied on the inner facing layer 26 of a finished face mask 20. The solution is within the range of approximately 10 wt. % to approximately 35 wt. % Aloe Vera, approximately 5 wt % to approximately 15 wt. % water soluble Vitamin E, approximately 3 wt % to approximately 7 wt % Grape Seed Extract, approximately 1% wt to approximately 5 wt. % Vitamin C, approximately 1 wt. % to approximately 3 wt. % Peppermint and approximately 35 wt. % to approximately 80 wt. % water.

The inner facing layer 26 is coextensive with the other layers 24, 25, and is a non-water repellent layer 26 made of synthetic fibers, natural fibers, and combinations thereof. The inner facing layer 26 is selected from the group consisting of the fabrics wet-laid fabrics, spunbonded fabrics, spunlaced fabrics, thermal bonded fabrics, SMS laminate, soft porous paper and cover stock, non-wovens, wovens, foams, films, and laminates and combinations thereof. The inner facing layer 26 has a basis weight from approximately 5 g/m_to approximately 120 g/m_, and also has a quantity of the said skin care composition on it, that is within the range of approximately 0.08 g/m_to approximately 75 g/m_.

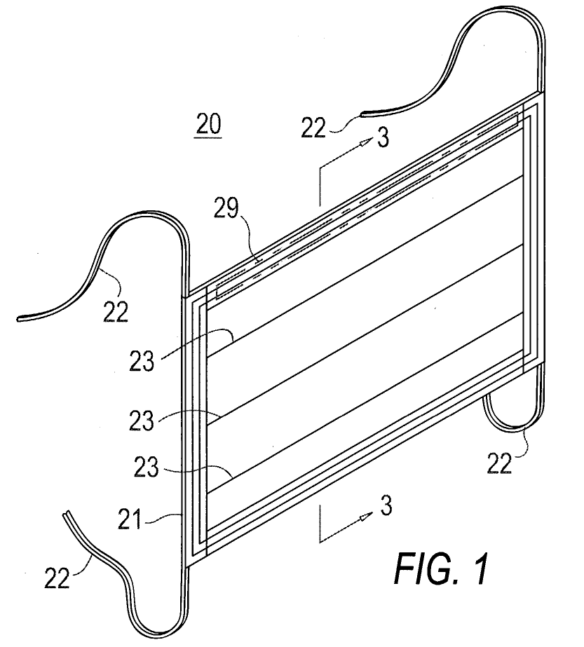

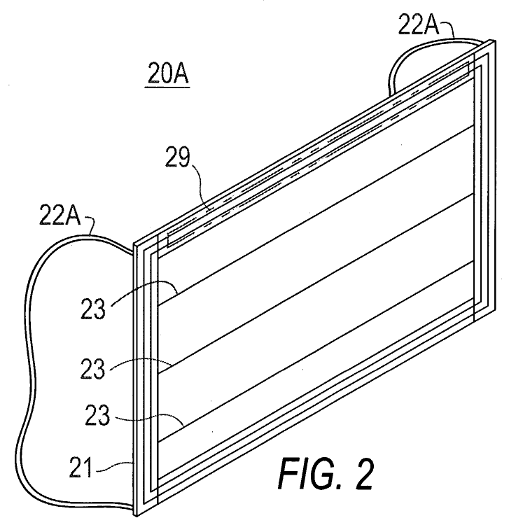

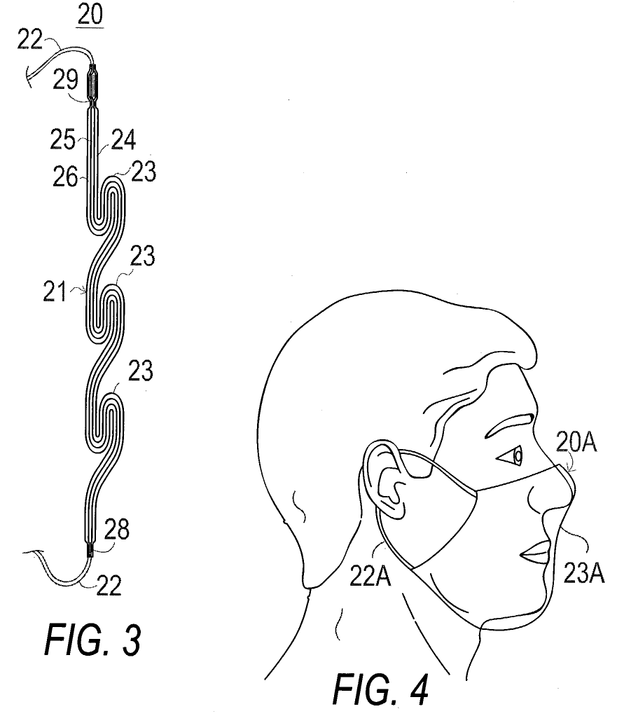

The disposable face mask 20 comprises three layers (as shown in FIG. 3); at least one intermediate filter media layer 25, at least one outer facing layer 24 and an inner facing skin care layer 26. The three layers 24, 25, 26 have three separate folds 23 that allow for expansion 23A (as shown in FIG. 2) when the mask 20 is being worn. The edges 28 of the three layers 24, 25, 26 are glue stamped to seal them or sealed by conventional ultrasonic bonding. The body 21 of the face mask 20 is also glue stamped or sealed by conventional ultrasonic bonding at the edges 28 to the tie straps 22 (shown in FIGS. 1& 2) or the elastic 22A (shown in FIG. 4). A bendable rib 29 is sealed inside of the edge 28 located at the top of the disposable face mask 20.

In practice the user would place the body 21 of the face mask 20 over their nose and mouth. To secure the face mask 20 it would be necessary to either tie the straps 22 or stretch the elastic 22A behind the ears. A final adjustment to seal the mask 20 to the nose would be required, and could be done by forming the bendable rib 29 around and over the bridge of the nose.

It is understood that the preceding description is given merely by way of illustration and not in limitation of the invention and that various modifications may be made thereto without departing from the spirit of the invention as claimed.

What is claimed is:

1. A disposable multiple layer face mask comprising:
at least one skin care layer comprising an inner facing layer adjacent to the skin coated with at least one moisturizing and therapeutic skin care composition impregnating the skin care layer, the at least one skin care composition capable of being released in a moist environment by perspiration and warm, moist air exhaled by a wearer and the at least one skin care composition capable of being transferable to the wearer's skin by normal contact;
at least one intermediate filter media layer; and
at least one outer facing layer.

2. The face mask of claim 1 wherein the inner facing layer is coated by an impregnating of the layer with a solution comprising at least one moisturizing and therapeutic composition selected from the group of moisturizing and therapeutic compositions including Aloe Vera, Vitamin E, Vitamin C, Grape Seed Extract and Peppermint.

3. The face mask of claim 1 wherein the inner facing layer is coated by an impregnating of the layer with a solution comprising at least two moisturizing and therapeutic compositions selected from the group of moisturizing and therapeutic compositions including Aloe Vera, Vitamin E, Vitamin C, Grape Seed Extract and Peppermint.

4. The face mask of claim 1 wherein the inner facing layer is coated by an impregnating of the layer with a solution comprising at least three moisturizing and therapeutic compositions selected from the group of moisturizing and therapeutic compositions including Aloe Vera, Vitamin E, Vitamin C, Grape Seed Extract and Peppermint.

5. The face mask of claim 1 wherein the inner facing layer is coated by an impregnating of the layer with a solution comprising Aloe Vera and Vitamin E.

6. The face mask of claim 5 wherein the inner facing layer is coated by an impregnating of the layer with a solution further comprising Vitamin C, Grape Seed Extract and Peppermint.

7. The face mask of claim 2 wherein a coating method used to apply the solution of at least one moisturizing and therapeutic composition to the innermost layer is selected from the group of methods including dip coating, spray coating, roll coating and rod coating.

8. The face mask of claim 7 wherein the solution of at least one moisturizing and therapeutic composition is applied to the inner facing layer of a finished face mask.

9. The face mask of claim 7 wherein the solution of at least one moisturizing and therapeutic composition is applied on a series of continuous webs forming the layer before the webs being cut to define individual mask bodies.

10. The face mask of claim 2 wherein the solution of at least one moisturizing and therapeutic composition is applied onto fibers and fibrous materials used to form the fabrics above before or during the forming of a series of continuous webs forming the fabrics.

11. The face mask of claim 7 wherein the Vitamin E used in the solution is water soluble Vitamin E.

12. The face mask of claim 1 wherein the inner facing layer is coextensive with the other layers.

13. The face mask of claim 1 wherein the inner facing layer is a non water repellency layer.

14. The face mask of claim 1 wherein the inner facing layer is made of synthetic fibers, natural fibers, and combinations thereof.

15. The face mask of claim 1 wherein the inner facing layer is selected from the group of layers consisting of wet-laid fabrics, spunbonded fabrics, spunlaced fabrics, thermal bonded fabrics, SMS laminate, soft porous paper and cover stock, nonwovens, wovens, foams, films, and laminates and combinations thereof.

16. The face mask of claim 1 wherein the inner facing layer has a basis weight of from approximately 5 g/m to approximately 120 g/m.
